(19) United States
(12) Patent Application Publication
(10) Pub. No.: US 2012/0269239 A1
(43) Pub. Date: Oct. 25, 2012

(54) Method and Apparatus for Data Transmission Oriented on the Object, Communication Media, Agents, and State of Communication Systems

(76) Inventor: Mykhaylo Sabelkin, Montreal (CA)

(21) Appl. No.: 13/090,608

(22) Filed: Apr. 20, 2011

(51) Int. Cl. H04B 1/38; G06F 17/10

(52) U.S. Cl. 375/219; 703/2

(57) ABSTRACT

A method and apparatus for Data Transmission Oriented on the Object, Communication Media, Agents, and State of Communication Systems (TOMAS) is disclosed. The efficiency of data communication of the proposed method is superior to the one of the conventional systems. This is achieved by matching the requirements (restored data quality, transmission speed, etc.) of agents (ex. a human, hardware device, firmware, software) to capabilities of the communication systems (ex. hardware, firmware and software performance; screen size, etc.) and the communication media (ex. a wireless link, twisted pair cable, coaxial cable, fiber optic link, waveguide, etc.), and exploiting certain data object (audio, video, control data, etc.) features. The superior efficiency is also achieved by using a fast algorithm at the stage of data object analysis-synthesis and the codestream multiplexing-demultiplexing.

### CROSS-REFERENCE TO RELATED APPLICATIONS

### Related U.S. Application Data

Provisional application No. 61/326,579, filed on Apr. 21, 2010

### Foreign Application Priority Data

May 3, 2010

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of data communication. More particularly, the present invention is in the technical field of wired and wireless data communication systems. The data communication systems, other than wireless, are considered as the wired data communication systems. Data communication systems serve to transmit certain data from one place to another. Conventional data communication systems have limited capabilities in parameters that characterize efficiency of data transmission.

### BRIEF SUMMARY OF THE INVENTION

The present invention is a method and apparatus for Data Transmission Oriented on the Object, Communication Media, Agents, and State of Communication Systems (TOMAS). The efficiency of data communication of the proposed apparatus is superior than the one of the conventional data communication systems. The superior efficiency is achieved by matching the requirements of agents with capabilities of the communication systems and the communication media using the features of the data objects. Data objects are represented by the digital or/and non-compressed data of different type, size, nature, etc. The object can be a one-dimensional (1D) signal, such as an audio signal, a voice, a control sequence; or/and a two-dimensional (2D) signal, such as an grayscale image; or/and a three dimensional signal (3D), such as a static 3D mesh or a color image; or/and a four dimensional signal, such as a dynamic 3D mesh or a color video signal; or/and a five dimensional signal such as a stereo color video signal. The communication media is a wireless link, a twisted pair cable, a coaxial cable, a fiber optic link, or a waveguide. The agents can be human or/and not human. The not human agent is represented by a hardware device or/and a firmware program or/and a software program. The communication systems are complex devices that employ multiple hardware, firmware and software components. An efficient data communication depends on reliable functioning of all components. It is provided by monitoring of time-varying characteristics of all components, such as a charge of batteries and a status of all hardware, firmware and software components. An efficient data communication also depends on information about time-invariant characteristics of the systems, such as devices screen sizes, employed operational systems (OS), etc. The superior efficiency of TOMAS is also achieved by using a fast analysis-synthesis algorithm at the stage of data object analysis-synthesis and the codestream multiplexing-demultiplexing. The superior efficiency of TOMAS for wireless communication media is achieved by modeling a wireless channel profile using a fast analysis-synthesis algorithm. The obtained channel model predicts attenuations of each of subbands. Use of this information allows organizing datastream coding, mapping and multiplexing more efficiently.

### BRIEF DESCRIPTION OF THE DRAWINGS

FIG. 1 is a general structure of the Data Transmission Oriented on the Object, Communication Media, Agents, and State of Communication Systems;

FIG. 2 is a TOMAS transceiver structure;

FIG. 3 is a data communication using two TOMAS transceivers;

FIG. 4 is a structure of the data segment after the bit-plan conversion;

FIG. 5 are the elementary cells W₂ and V₂;

FIG. 6 is the Fast Fourrier Transform (FFT) butterfly;

FIG. 7 is the scheme of the third level of the analysis-synthesis of the digital signal x[n];

FIG. 8 is the scheme of the W₄ cell as a combination of four elementary cells W₂;

FIG. 9 is the W₄ cell structure;

FIG. 10 is the W₈ cell structure;

### DETAILED DESCRIPTION OF THE INVENTION

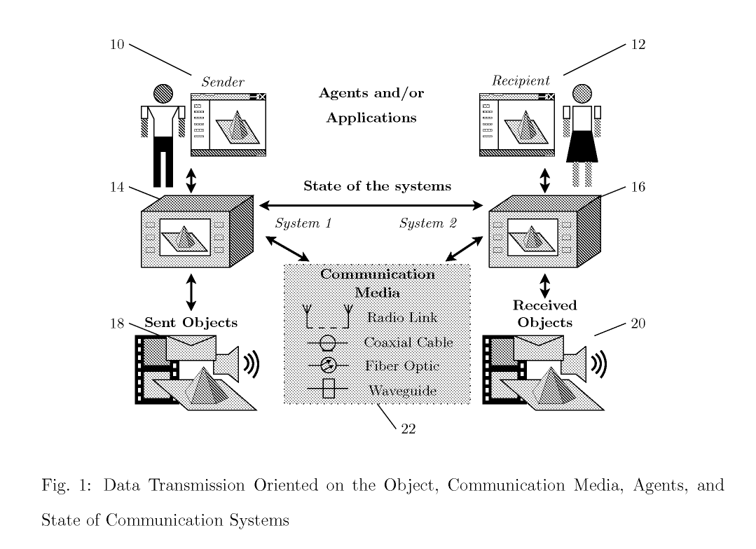

Referring now to the invention in more detail. Data Transmission Oriented on the Object, Communication Media, Agents, and State of Communication Systems is possible in case of two or more communication systems. In FIG. 1 there is shown a structure of the Data Transmission Oriented on the Object, Communication Media, Agents, and State of Communication Systems.

Sent objects 18 are represented by the digital or/and analog non-compressed data of different type, size, nature, etc. Received objects 20 are represented by the digital or/and analog compressed or non-compressed data of different type, size, nature, etc. The object can be a one-dimensional (1D) signal, such as an audio signal, a voice, a control sequence; or/and a two-dimensional (2D) signal, such as an grayscale image; or/and a three dimensional signal (3D), such as a static 3D mesh or a color image; or/and a four dimensional signal, such as a dynamic 3D mesh or a color video signal; or/and a five dimensional signal such as a stereo color video signal.

The object which contains a combination of the signals mentioned above can be referred as a multimedia object.

A communication media 22 is a wireless link, a twisted pair cable, a coaxial cable, a fiber optic link, or a waveguide.

A sender 10 and a recipient 12 are agents. The agents can be human or/and not human. The not human agent is represented by a hardware device or/and a firmware program or/and a software program.

A communication system 14 and a communication system 16 are complex devices that employ multiple hardware, firmware and software components. An efficient data communication depends on reliable functioning of all components. It is provided by monitoring of time-varying characteristics of all components, such as a charge of batteries and a status of all hardware, firmware and software components. An efficient data communication also depends on information about time-invariant characteristics of the systems, such as devices screen sizes, employed operational systems (OS), etc.

The sender 10 interacts with the communication system 14 to send the data objects 18. The communication system 14 interacts with the communication system 16 over the communication media 22 in order to determine the parameters of the communication media 22. The communication system 14 transforms the data objects 18 into data suitable to be transmitted over the communication media 22. The communication system 14 transmits the transformed data objects 18 to the communication system 16 over the communication media 22 once the link between the communication system 14 and the communication system 16 has been established. The communication system 16 receives the data from the communication system 14. Often the received data is not the same one which has been transmitted by the communication system 14 due to distortion and/or corruption in the communication media 22. That is why the received objects 20 are not often the same ones which has been transmitted by the communication system 14. The communication system 16 implements an inverse transform of the received data in order to obtain the received objects 20. A recipient 12 interacts with a communication system 16 to obtain the received objects 20. The recipient 12 interacts with the sender 10 to provide a feedback information about parameters of the received objects 20. The sender 10 interacts with the recipient 12 to obtain an information about the received objects' 20 parameters required by the recipient 12.

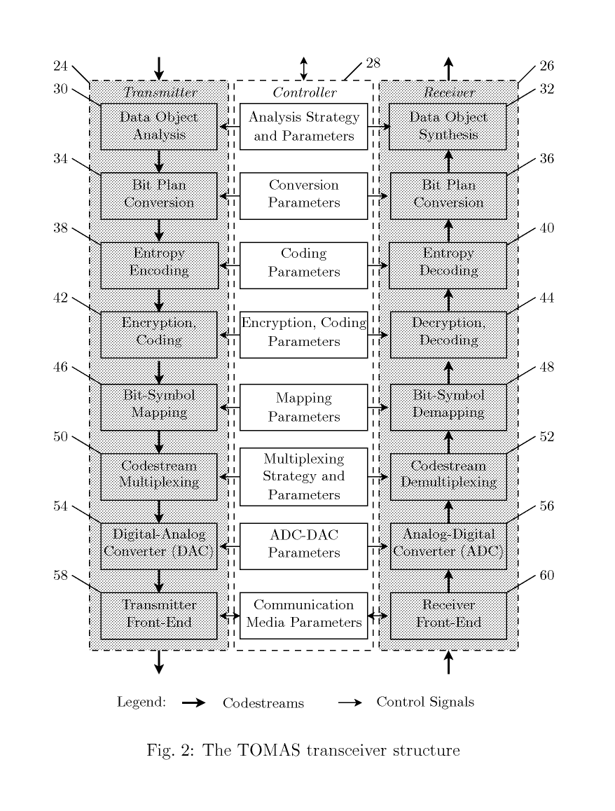

FIG. 2 represents the structure of communication systems 14 and 16. Each of the systems 14 and 16 consist of a transmitter 24, a receiver 26, and a controller 28. The system which contains both the transmitter and the receiver is often referred as a transceiver. Hence FIG. 2 represents the structure of the transceiver which employs a method of Data Transmission Oriented on the Object, Communication Media, Agents, and State of Communication Systems. Further the transceiver shown on FIG. 2 is referred as the TOMAS transceiver.

The transmitter 24 consists of a data object analysis block 30, a bit-plan conversion block 34, an entropy encoding block 38, an encryption or/and channel coding block 42, a bit-symbol mapping block 46, a codestream multiplexing block 50, a digital-to-analog (DAC) signal converter block 54, and a transmitter front-end block 58.

The transmitter 24 inputs the sent objects 18, and outputs the data suitable to be transmitted over the particular communication media 22.

The receiver 26 consists of a data object synthesis block 32, a bit-plan conversion block 36, an entropy decoding block 40, an decryption or/and channel decoding block 44, a bit-symbol demapping block 48, a codestream demultiplexing block 52, an analog-to-digital (ADC) signal converter block 54, and a receiver front-end block 60.

The receiver 26 inputs the data transmitted over the particular communication media 22, and outputs the received objects 20

The controller 28 operates with all transceiver parameters. They are the data object analysis and decomposition parameters, the bit-plan conversion parameters, the entropy encoding parameters, the encryption or/and channel coding parameters, the bit-symbol mapping parameters, the codestream multiplexing parameters, digital-to-analog and analog-to-digital conversion parameters, and communication media front-end parameters.

The controller 28 interacts with the sender 10. The controller 28 also interacts with the recipient 12 via the communication media 22.

Legend on FIG. 2 emphasize that the bold arrows between blocks represent codestreams, and the thin arrows represent control signals.

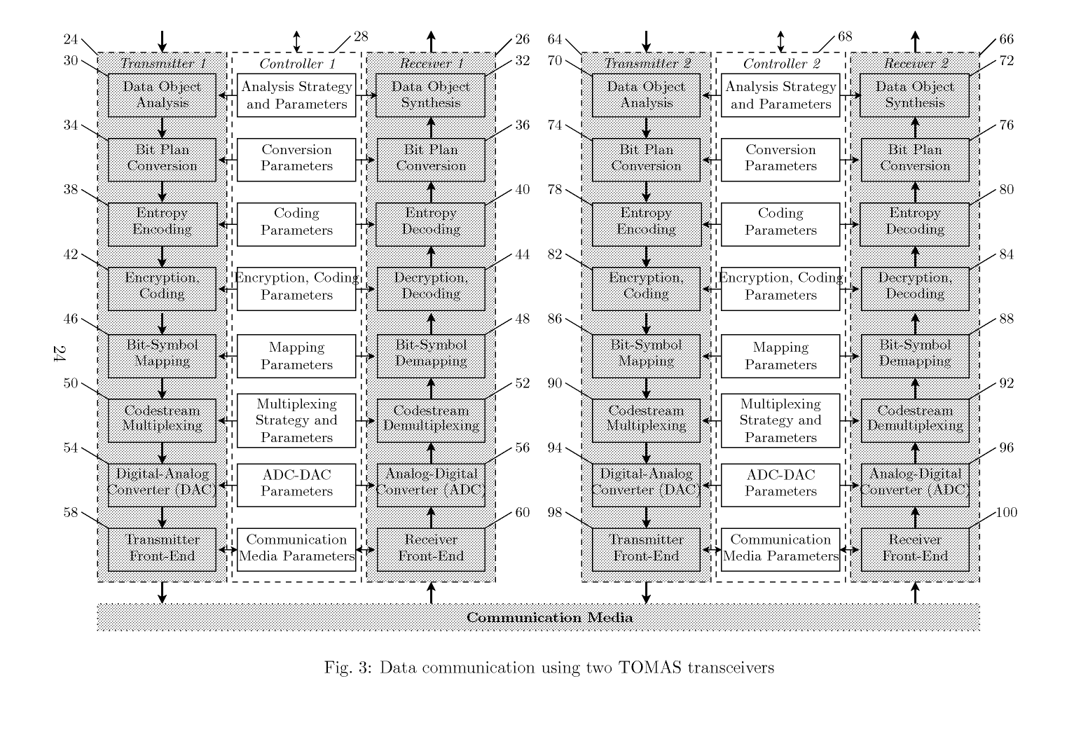

The communication system 14 is called the first TOMAS transceiver. The communication system 16 is called the the second TOMAS transceiver. Data communication using two TOMAS transceivers is shown on FIG. 3. The first TOMAS transceiver consists of a transmitter 24, a receiver 26 and a controller 28. The second TOMAS transceiver consists of a transmitter 64, a receiver 66 and a controller 68.

Data communication between two TOMAS transceivers is devided into two stages. The first stage is establishing a link between two TOMAS transceivers. The second stage is actual data transmission from one transceiver to another.

At the first stage, the controller 28 checks the state of the hardware, firmware and software components of the first TOMAS transceiver 14, and the controller 68 checks the state the state of the hardware, firmware and software components of the second TOMAS transceiver 16.

In case all components of the first TOMAS transceiver 14 are functional, the controller 28 responds to the agent 10 that the TOMAS transceiver 14 is fully operational and the data communication is possible. In case all components of the second TOMAS transceiver 16 are functional, the controller 68 responds to the agent 12 that the TOMAS transceiver 16 is fully operational and the data communication is possible.

In case some non-significant component of the first TOMAS transceiver 14 is not functional, the controller 28 returns to the agent 10 a set of the hardware, firmware and software components' configurations that make the the TOMAS transceiver 14 partially operational and data communication possible. In case some non-significant component of the second TOMAS transceiver 16 is not functional, the controller 68 returns to the agent 12 a set of the hardware, firmware and software components' configurations that make the the TOMAS transceiver 16 partially operational and data communication possible.

In case some critical component of the first TOMAS transceiver 14 is not functional, the controller 28 responds to the agent 10 that the TOMAS transceiver 14 is not operational and the data communication is impossible. In case some critical component of the second TOMAS transceiver 16 is not functional, the controller 68 responds to the agent 12 that the TOMAS transceiver 16 is not operational and the data communication is impossible.

After the controller 28 determined that the TOMAS transceiver 14 is fully or partially operational it commands the transmitter 24 to send a “handshake” signal to the TOMAS transceiver 16 over the communication media 22.

After the controller 68 determined that the TOMAS transceiver 16 is fully or partially operational it commands the receiver 24 to wait for the “handshake” signal from the TOMAS transceiver 14 over the communication media 22.

The procedure of sending the “handshake” signal might differ from one communication media type to another. In most cases it would be the signal of the certain frequency which is known a-priori by the transmitter 24 and the receiver 66.

After receiver 66 receives the “handshake” signal, the controller 68 commands the transmitter 64 to send a “link established” signal to the TOMAS transceiver 14.

In case communication media 22 is represented by multiple frequency channels, the procedure of sending the “handshake” signal might be repeated by the TOMAS transceiver 14 on multiple frequencies until the “link established” signal will be received from the TOMAS transceiver 16.

After establishing a link between two TOMAS transceivers, the controller 28 and the controller 68 exchange information about the hardware, firmware and software components' configurations and the states of each of the TOMAS transceivers.

The controller 28 commands the transmitter 24 to send a signal for measurement of the communication media parameters. The receiver 66 receives the measurement signal, and the controller 68 processes it by extracting the communication media parameters critical for the data communication. The controller 68 commands the transmitter 64 to send the communication media parameters to the receiver 26. The receiver 26 provides the controller 28 with the communication media parameters.

The controller 68 interacts with the recipient 12. The last one can impose certain requirements on the data objects he wants to receive. For example, in case of the image, the recipient 12 can ask the image of the different size or resolution. The controller 68 commands the transmitter 64 to send the recipient 12 requirements to the receiver 26. The receiver 26 provides the controller 28 with the the recipient 12 requirements.

The first stage of establishing a link between the TOMAS transceiver 14 and the TOMAS transceiver 16 is accomplished. After the first stage the controller 28 of the TOMAS transceiver 14 possesses the information about the communication media parameters, the information about the hardware, firmware and software components' configurations and the state of the TOMAS transceiver 16, and the information about requirements of the agent 12 on the data objects he wants to receive.

At the second stage of data transmission from the TOMAS transceiver 14 to the TOMAS transceiver 16, the controller 28 uses the information about the communication media parameters, the information about the hardware, firmware and software components' configurations and the state of both TOMAS transceivers 14 and 16, and the information about requirements of the agent 12 on the data objects he wants to receive.

The agent 10 provides the TOMAS transceiver 14 with the data objects 18. The agent 10 can provide the controller 28 the information about the nature of the data objects 18. The agent 10 can impose some requirements on how to proceed the treatment of the data objects 18. The agent 10 can propose the controller 28 which an analysis/synthesis technique to use for the particular data object. However the final choice of the data object analysis/synthesis technique is made by the controller 28. Since the controller 28 possesses the information about the communication media throughput capability, the information about the both TOMAS transceivers' capability, and the information about requirements of the agent 12 on the data objects he wants to receive.

The task of the controller 28 is to look for a compromise between agents' demands on object transmission and communication media/communication system abilities. In order to fulfill that task, the controller 28 assign appropriate parameters to the transceiver's 24 blocks.

The controller 28 chooses an appropriate analysis/synthesis technique for the particular data object. The chosen technique might be appropriate in terms of the received object quality, an algorithm computation speed or complexity, availability of hardware, firmware and software resources to implement such a technique at the moment. Even an intellectual property rights on some particular technique might be taken into consideration.

The data object analysis block 30 decompose the data object into data segments using the analysis technique assigned by the controller 28. Using some quality criterion of the restored data object, the controller 28 assigns every data segment with a certain index of importance. First data segment is considered to be more important than the second one if corruption of this segment causes more damage to the restored data object than corruption of the second segment. The data object analysis block 30 outputs the set of data segments ranked in descending order according to their importance. The data object analysis block 30 transfer to the controller 28 the list of the data segments ranked according to their importance.

The controller 28 commands the transmitter 24 to send the parameters of the analysis techniques of each of data objects, and the list of the data segments ranked according to their importance. The receiver 66 receives that data and transfer it to the controller 68. Afterwards, the controller 68 transfer the set of analysis parameters to the data object synthesis block 72.

The data object synthesis block 72 restores the data objects from the data segments. The restored data objects are transferred to the recipient 12 as the received objects 20.

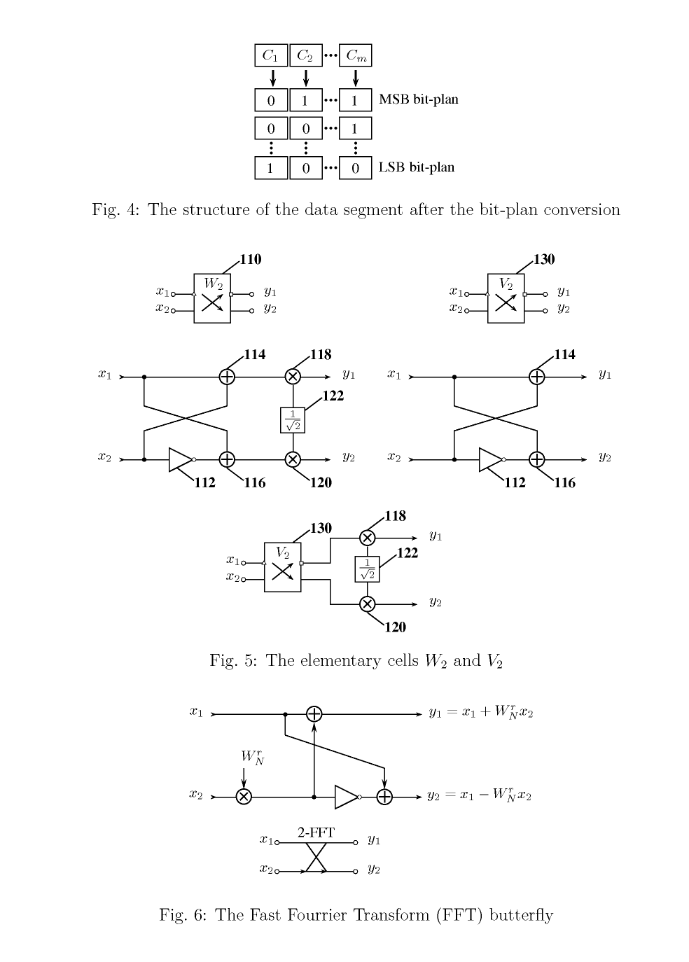

The data object analysis block 30 outputs the data segments represented by floating-point numbers. Upon a request of the controller 28, the bit-plan conversion block 34 transform the data segments' numbers into fixed-point representation. Truncation or rounding of floating-point numbers might cause the degradation of quality of the restored data object. The bit-plan conversion block 34 represents the second stage of decomposition of the data object into data segments of unequal importance. The bit-plans of the data segment is formed by grouping corresponding bits of the coefficients as it is shown on FIG. 4. The bit-plan of the data segment that consists of the Most Significant Bits (MSB) of the coefficients C₁ . . . Cₘ is considered to be the most important. The bit-plan of the data segment that consists of the Least Significant Bits (LSB) of the coefficients C₁ . . . Cₘ is considered to be the least important. Upon a request of the controller 28, the bits of each bit-plan are grouped into words. The word length can differ from one bit-plan to another as well as from one data segment to another.

The controller 28 commands the transmitter 24 to send the parameters of the bit-plan conversion of each of data objects' segments. The receiver 66 receives that data and transfer it to the controller 68. Afterwards, the controller 68 transfer the set of bit-plan conversion parameters to the bit-plan conversion block 76.

The entropy encoding block 38 serves to reduce the redundancy of the bit-plan data. The entropy encoding block might implement a Huffman or arithmetic encoding algorithm. The entropy encoding technique consists of two principal stages. The first one is to build the code from the data histogram. And the second one is to encode the data using the obtained code. Upon a request of the controller 28, the entropy encoding block 38 can process separately every data segment of every data object of every bit-plan. Or, upon the request of the controller 28, the entropy encoding block 38 can process separately the bit-plans of all data segments of every data object. Or, upon the request of the controller 28, the entropy encoding block 38 can process separately the bit-plans of all data segments of all data objects. Otherwords, the controller 28 can choose different bit-plan conversion strategy.

The controller 28 commands the transmitter 24 to send the parameters of the entropy encoding. The receiver 66 receives that data and transfer it to the controller 68. Afterwards, the controller 68 transfer the set of the entropy encoding parameters to the entropy decoding block 80.

The entropy encoding block 38 outputs multiple binary code streams of two types: data histograms and entropy encoded data. The data histograms serves to restore an original entropy code. This code is required to decode the entropy encoded data. The data histograms are small is size and very prone to corruption. The entropy encoded data is also prone to corruption. The following rule is true: the shorter entropy code, the less entropy encoded data is prone to corruption. However the shorter entropy code, the more entropy encoded data needs to be transmitted. The role of the controller 28 is to find an optimal code length to satisfy the conditions of the data transmission.

Upon request of the agents 10 and 12, the controller 28 can be required to apply encryption on bitstreams. This is implemented in the encryption/coding block 42. Given harsh communication media 22 conditions, the controller can command to apply a channel coding technique which is also implemented in the encryption/coding block 42.

The controller 28 commands the transmitter 24 to send the parameters of the encryption and/or channel coding. The receiver 66 receives that data and transfer it to the controller 68. Afterwards, the controller 68 transfer the set of the encryption and/or channel coding parameters to the decryption/decoding block 84. The encryption/coding block 42 outputs multiple bitstreams.

The bit-symbol mapping block 46 improve spectral efficiency of the TOMAS transceiver by mapping a group of bits into a complex symbol. Upon a request of the controller 28, every bitstream can be mapped using different or the same bit-symbol mapping technique. The type of the mapping technique depends on communication media's 22 conditions, a digital-to-analog converter (DAC) block's 54 resolution and analog-to-digital converter (ADC) block's 96 resolution. For example, the controller 28 cannot propose the 10 bit quadrature amplitude bit-symbol mapping in case the resolution of the analog-to-digital converter 96 is eight bit only and noise level in the communication channel is too high. In most cases the bit-symbol mapping block 46 outputs the multiple parallel streams of complex symbols.

The controller 28 commands the transmitter 24 to send the parameters of the bit-symbol mapping. The receiver 66 receives that data and transfer it to the controller 68. The controller 68 transfer the set of the bit-symbol mapping parameters to the bit-symbol demapping block 88.

The multiple parallel code streams of complex symbols are multiplexed by the codestream multiplexing block 50 in order to be sent serially. This parallel-to-serial conversion can be implemented by the Time-Division Multiplexing (TDM), or the Code-Division Multiplexing (CDM), or Frequency Division Multiplexing (FDM), or Orthogonal Frequency Division Multiplexing (OFDM), or a multiplexing based on a W_{N} cell (N−2ⁿ, n ∈ Z) described later. The superior efficiency of TOMAS for wireless communication media is achieved by modeling a wireless channel profile using a fast analysis-synthesis algorithm. The obtained channel model predicts attenuations of each of subbands. Use of this information allows organizing datastream coding, mapping and multiplexing more efficiently.

The controller 28 chooses an appropriate parallel-to-serial conversion technique. The controller 28 commands the transmitter 24 to send the parameters of the parallel-to-serial conversion technique. The receiver 66 receives that data and transfer it to the controller 68. The controller 68 transfer the set of the parallel-to-serial conversion parameters to the codestream demultiplexing block 92.

The digital-to-analog converter (DAC) block 54 transforms a serial complex digital signal of fixed bit resolution into an analog signal, often called an intermediate frequency (IF) signal.

The TOMAS transceiver 14 contains a transmitter front-end 58 and a receiver front-end 60. The TOMAS transceiver 16 contains a transmitter front-end 98 and a receiver front-end 100. A type of front-end depends on the communication media 22. The wireless link, the twisted pair cable, the coaxial cable, the fiber optic link, or the waveguide require different transmitter and receiver front-ends. Commonly, the transmitter front-end 58 and 98 transform the intermediate frequency (IF) signals into higher frequency signals and transmit them over some particular communication media. In some cases the high-frequency signal is transmitted over multiple communication media. For example, the coaxial cable is connected from the transmitter output to the antenna emitting in an open space. Another coaxial cable is connected from the antenna to the receiver input. In this case we have three communication media serving as the communication media 22.

The receiver front-ends 60 and 100 receive higher frequency signals and transform them into intermediate frequency (IF) signals.

Using the parameters provided by the controller 68, the analog-to-digital converter (ADC) block 96 transforms the analog intermediate frequency (IF) signal into the serial complex digital signal of fixed bit resolution.

Using the parameters provided by the controller 68, the codestream demultiplexing block 92 transforms the serial codestream into the multiple parallel codestreams.

Using the parameters provided by the controller 68, the bit-symbol demapping block 88 transforms the multiple parallel codestreams of complex symbols into the multiple parallel binary codestreams.

Using the parameters provided by the controller 68, the decryption/channel decoding block 84 transforms the multiple parallel binary codestreams into the multiple parallel bitstreams.

Using the parameters provided by the controller 68, the entropy decoding block 80 rebuilds the entropy code from the received histograms, and decodes the data segment words.

Using the parameters provided by the controller 68, the bit-plan conversion block 76 transforms the data segment words into the data segment bit-plans and afterwards into the coefficients of data object segments.

Using the parameters provided by the controller 68, the data object synthesis block 72 assembles the data objects from their segments.

Finally, the recepient 12 receives their data objects.

### The Elementary Cell W₂

Consider one TOMAS transceiver shown on FIG. 2. In our invention the elementary cells W₂ and V₂ is implemented in the data object analysis block 30, the data object synthesis block 33, the codestream multiplexing block 50 and the the codestream demultiplexing block 52. The elementary cell W₂ 110 and the elementary cell V₂ 130 are shown on FIG. 5.

The elementary cell W₂ 110 consists of an inverter 112, an adder 114, an adder 116, a multiplier 118, a multiplier 120, and a block 122 generating a constant 1/\sqrt{2}.

The elementary cell V₂ 130 consists of the inverter 112, the adder 114, and the adder 116.

In other view, the elementary cell W₂ 110 consists of the elementary cell V₂ 130, a multiplier 118, a multiplier 118, and a block 122 generating a constant

$$\frac{1}{\sqrt{2}} .$$

The elementary cell W₂ 110 possesses a particular property which allows it to be used both for analysis and synthesis.

In case the elementary cell W₂ 110 is used for analysis of the digital signal x[n], the odd samples of the signal x[2n−1] inputs to a pin x₁ and the even samples of the signal x[2n] inputs to a pin x₂.

In case the elementary cell W₂ 110 is used for analysis of the digital signal x[n], the pin y₁ outputs the approximation signal

$$A [ k ] = \frac{1}{\sqrt{2}} ( x [ 2 n - 1 ] + x [ 2 n ] ) ,$$

and the pin y₂ outputs the detail signal

$$D [ k ] = \frac{1}{\sqrt{2}} ( x [ 2 n - 1 ] - x [ 2 n ] ) .$$

In case the elementary cell W₂ 110 is used for synthesis of the digital signal x[n], the approximation signal A[k] inputs to the pin x₁ and the detail signal D[k] inputs to the pin x₂.

In case the elementary cell W₂ 110 is used for synthesis of the digital signal x[n], the pin y₁ outputs the odd samples of the signal

$$x [ 2 n - 1 ] = \frac{1}{\sqrt{2}} ( A [ k ] + D [ k ] ) ,$$

and the pin y₂ outputs the even samples of the signal

$$x [ 2 n ] = \frac{1}{\sqrt{2}} ( A [ k ] - D [ k ] ) .$$

The assignments for Input/Output pins are presented in Table 1.

TABLE 1
Input/Output pin assignment of the fast elementary cell

| Input | Analysis | Synthesis | Output | Analysis | Synthesis |
|---|---|---|---|---|---|
| x₁ | x[2n − 1] | A[k] | y₁ | A[k] | x[2n − 1] |
| x₂ | x[2n] | D[k] | y₂ | D[k] | x[2n] |

Nowadays, the most common algorithm in Digital Signal Processing (DSP) is the Fast Fourrier Transform (FFT). FIG. 6 shows is the two-point Fast Fourrier Transform (FFT), or 2-FFT decimation-in-time butterfly.

The first advantage the elementary cell W₂ 110 over 2-FFT is that the elementary cell W₂ 110 can be used for both data analysis and data synthesis.

The second advantage the elementary cell W₂ 110 is that it's complexity is less than the one of the 2-FFT. The results are presented in Table 2. The complexity of an algorithm is measured by the quantity of real adders (⊕), the quantity of real multipliers ( [symbol] ) and the quantity of real inverters (◯). Use of the elementary cell W₂ 110 and the elementary cell V₂ 130 do not change the nature of input numbers, i.e. the real input numbers stay real. However, output of 2-FFT butterfly is always represented by complex numbers. Since, the 2-FFT butterly is applied more than ones, the input of the next stage 2-FFT operation will be complex, and there is no reason to consider the real input numbers for 2-FFT. Therefore the slot, corresponding to the number of operations on real input numbers, is empty in Table 2.

TABLE 2
Complexity of W₂, V₂ cells and 2-FFT
butterfly in terms of real operations

| Input numbers | W₂ | V₂ | 2-FFT |
|---|---|---|---|
| Real | 2 ⊕ + 2 [symbol] + 1⊖ | 2 ⊕ + 1⊖ | n/a |
| Complex | 4 ⊕ + 4 [symbol] + 2⊖ | 4 ⊕ + 2⊖ | 6 ⊕ + 4 [symbol] + 3⊖ |

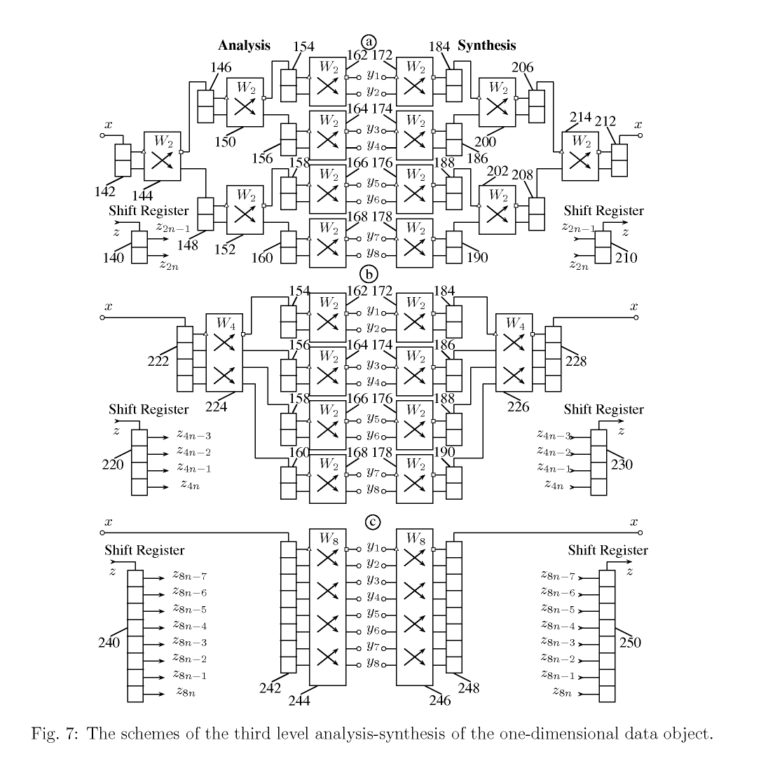

The elementary cell W₂ 110 outputs the approximation and detail features of the input signal. The controller 28 might decide to continue the procedure by analysing the features of features etc. The decision of the controller 28 is based on certain criteria. The controller 28 commands the data object analysis block 30 to stop the analysis upon a certain parameter of feature segment is reached. FIG. 7 shows the schemes of the third level analysis-synthesis of the one-dimensional data object x[n].

### The W₄ and W₈ Cells

The scheme on FIG. 7a) is purely based on the elementary cells W₂ 110. The third level analysis scheme consists of seven elementary cells W₂ (144, 150, 152, 162, 164, 166, 168), and seven shift registers (142, 146, 148, 154, 156, 158, 160). The shift register 140, used in the analysis scheme, outputs two datastreams. The first datastream consists of the odd samples z₂ₙ₋₁ of the input datastream z. The second datastream consists of the even samples z₂ₙ of the input datastream z. The third level synthesis scheme consists of seven elementary cells W₂ (172, 174, 176, 178, 200, 202, 214), and seven shift registers (184, 186, 188, 190, 206, 208, 212). The shift register 210, used in the synthesis scheme, inputs two datastreams. The first datastream consists of the odd samples z₂ₙ₋₁ of the output datastream z. The second datastream consists of the even samples z₂ₙ of the output datastream z.

In case the controller 28 posesses enough resources, the computational speed of the analysis-synthesis can be increased by applying parallel computing techniques instead of serial ones. The scheme on FIG. 7b) is based on the combination of the elementary cells W₂ 110 and W₄ cells. The third level analysis scheme consists of one W₄ cell 224, four elementary cells W₂ (162, 164, 166, 168), a four stage shift register 222, and four shift registers of type 140 (154, 156, 158, 160). The four stage shift register 220, used in the analysis scheme, outputs four datastreams. The four stage shift register 220 serves as a serial-to-parallel converter. The third level synthesis scheme consists of one W₄ cell 226, four elementary cells W₂ (172, 174, 176, 178), four shift registers of type 210 (184, 186, 188, 190), and a four stage shift register 230. The four stage shift register 230, used in the synthesis scheme, inputs four datastreams. The four stage shift register 230 serves as a parallel-to-serial converter.

In case the controller 28 posesses even more resources, the computational speed of the analysis-synthesis can be increased even more. The scheme on FIG. 7c) is based on W₈ cells. The third level analysis scheme consists of one W₈ cell 244, and an eight stage shift register 242. The eight stage shift register 240, used in the analysis scheme, outputs eight datastreams. The four stage shift register 240 serves as a serial-to-parallel converter. The third level synthesis scheme consists of one W₈ cell 246, and an eight stage shift register 248. The eight stage shift register 250, used in the synthesis scheme, inputs eight datastreams. The eight stage shift register 250 serves as a parallel-to-serial converter.

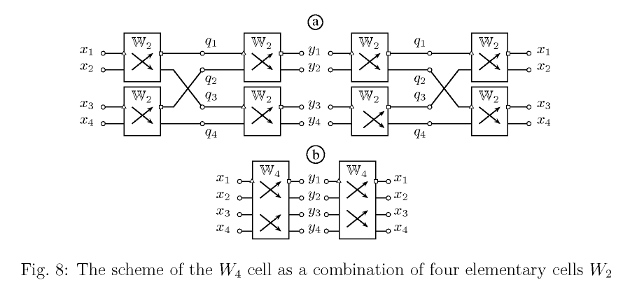

FIG. 8 shows the scheme of the W₄ cell as a combination of four elementary cells W₂.

The W₄ cell can be employed for analysis-synthesis of two-dimensional data object, or image. During analysis the W₄ cell transforms four image pixels (X[2n−1, 2m−1], X[2n−1, 2m], X [2n, 2m−1], X[2n, 2m]) into an approximation (A[n, m]) coefficient, and three detail coefficients: horizontal (H[n, m]), vertical (V[n, m]) and diagonal (D[n, m]). During synthesis the W₄ cell transforms the approximation (A[n, m]) coefficient, and three detail coefficients: horizontal (H[n, m]), vertical (V[n, m]) and diagonal (D[n, m]) into four image pixels (X[2n−1, 2m−1], X[2n−1, 2m], X[2n, 2m−1], X[2n, 2m]). Where n=1 . . . N, m=1 . . . M, N×M is the image size. The assignments for Input/Output pins are presented in Table 3 for both cases of use the two-dimensional elementary cell in image analysis and synthesis.

TABLE 3
Input/Output pin assignment of the 2D fast elementary cell

| Input | Analysis | Synthesis | Output | Analysis | Synthesis |
|---|---|---|---|---|---|
| x₁ | X[2n − 1, | A[n, m] | y₁ | A[n, m] | X[2n − 1, |
| | 2m − 1] | | | | 2m − 1] |
| x₂ | X[2n − 1, | H[n, m] | y₂ | H[n, m] | X[2n − 1, |
| | 2m] | | | | 2m] |
| x₃ | X[2n, | V[n, m] | y₃ | V[n, m] | X[2n, |
| | 2m − 1] | | | | 2m − 1] |
| x₄ | X[2n, 2m] | D[n, m] | y₄ | D[n, m] | X[2n, 2m] |

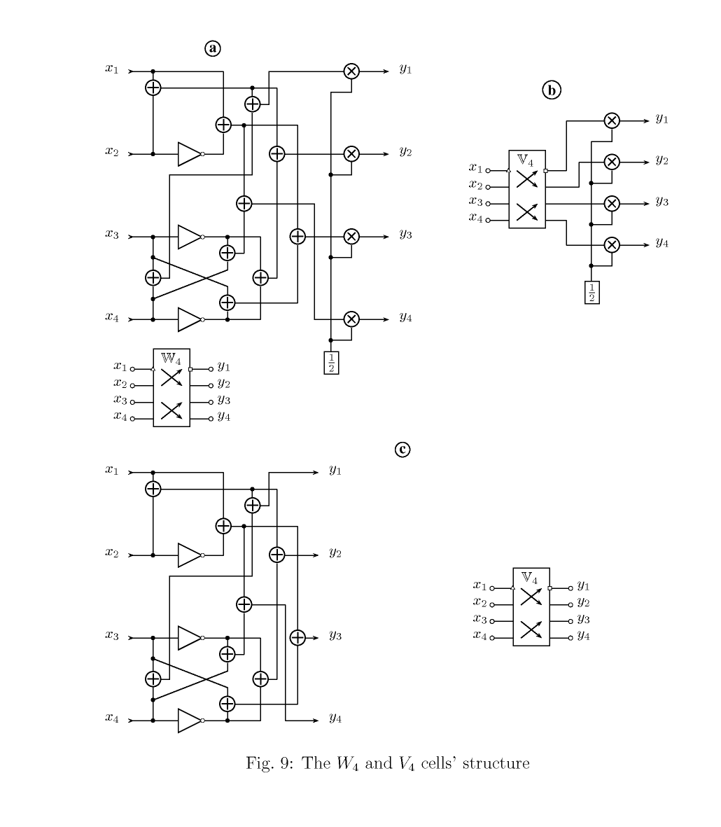

FIG. 9 shows the structure of the W₄ and V₄ cells as a combination inverters, adders, multipliers, and blocks generating a constant ½. Complexities W₄ and V₄ cells are presented in 4

TABLE 4
Complexity of W₄, V₄ cells in terms of real operations

| Input numbers | W₄ | V₄ |
|---|---|---|
| Real | 10 ⊕ + 4 [symbol] + 3⊖ | 10 ⊕ + 3⊖ |
| Complex | 20 ⊕ + 8 [symbol] + 10⊖ | 20 ⊕ + 6⊖ |

An operation of multiplication by ½ can be replaced by the shift operation. In that case no multiplication operations required in W₄.

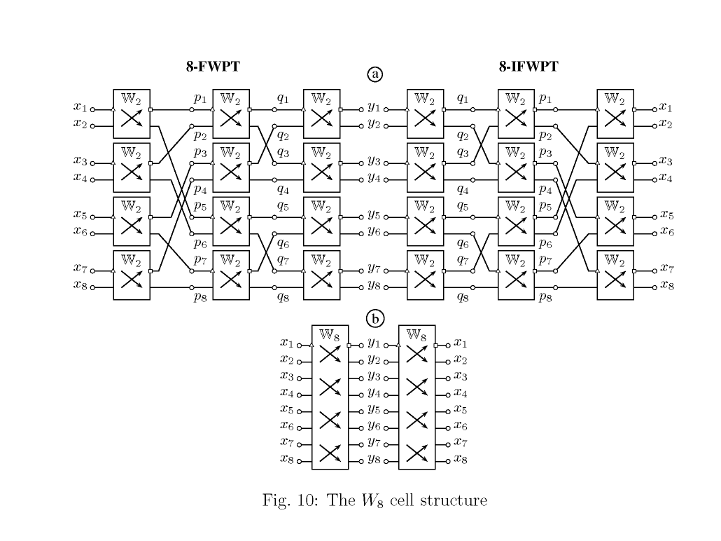

FIG. 10 shows the structure of the W₈ cell as a combination of the W₂ cells;

Generally, the W_{N} cell (N=2ⁿ, n ∈ Z) can be build. It will be able to operate on N data points simultaneously. The only limitation is the TOMAS system resources.

The complexity of W_{N} cell (N=2ⁿ, n ∈ Z) is compared with the complexity of the N-point Fast Fourier Transform (FFT) are presented in Table 5.

The elementary cell W₂ 110 can be envisioned as the elementary cell V₂ 114 whose output is multiplied by

$$\frac{1}{\sqrt{2}} .$$

By analogy, the W_{N} can be envisioned as the V_{N} whose output is multiplied by

$${( \frac{1}{\sqrt{2}} )}^{d} = {2}^{- \frac{d}{2}} ,$$

where d=log₂N. In case d=2k is even, the multiplier

$${2}^{- \frac{d}{2}} = {2}^{- k}$$

can be replaced by the shift register. In case d=2k+1 is odd, the multiplier can be envisioned as the two multipliers

$${2}^{- \frac{2 k + 1}{2}} = {2}^{- k} \cdot \frac{1}{\sqrt{2}} .$$

Multiplication by 2^{-k} can be replaced by the shift register, however multiplication by

$$\frac{1}{\sqrt{2}}$$

should be implemented. Totally N multipliers by

$$\frac{1}{\sqrt{2}}$$

are required for the W_{N} in case d 32 log₂N is odd.

TABLE 5
Complexity of the N-point FWPT vs. the N-point FFT
in terms of real operations

| Input | | |
|---|---|---|
| numbers | W_{N} | FFT |
| Real | $\frac{N}{2} {log}_{2} N ( 2 ⊕ + 1 ⊖ ) + β N ⊗$ | n/a |
| Complex | $\frac{N}{2} {log}_{2} N ( 4 ⊕ + 2 ⊖ ) + 2 β N ⊗$ | $\begin{matrix}\frac{N}{2} {log}_{2} N ( 6 ⊕ + \\ 4 ⊗ + 3 ⊖ )\end{matrix}$ |
| | $where β = \{ \begin{matrix}0 if d = {log}_{2} N is even \\ 1 if d = {log}_{2} N is odd\end{matrix}$ | |

### Performance Parameters of Communication System

In order to evaluate the performance of a communication system, the following parameters are used:

$$\begin{matrix}Spectral Efficiency = \frac{Total Object Bits}{Transmitted Symbols} , & ( 1 ) \\ Complexity = \frac{Total Processing Operations}{Total Object Bits} , \\ where & ( 2 ) \\ Total Object Bits = N \cdot M \cdot bit \text{-} per \text{-} pixel . & ( 3 )\end{matrix}$$

In our case, the Spectral Efficiency (1) is measured in bits-per-symbol. It depends on the number of transmitted symbols. The goal of the communication system is to represent the Data Object by a minimal number of symbols. Let us note that, in case of fixed symbol mapping parameters, any kind of channel coding employed by the system will decrease the spectral efficiency.

The complexity of the communication system is measured by the Algorithm Complexity parameter (2). It reflects how many real additions and multiplications are required in order to process one bit of the transmitted data object.

That which is claimed:

1. A method and apparatus for Data Transmission Oriented on the Object, Communication Media, Agents, and State of Communication Systems (TOMAS).

2. Apparatus as claimed in claim 1, wherein said the data objects are represented by the digital and/or analog non-compressed data of different type, size, nature, etc. The object can be a one-dimensional (1D) signal, such as an audio signal, a voice, a control sequence; or/and a two-dimensional (2D) signal, such as an grayscale image; or/and a three dimensional signal (3D), such as a static 3D mesh or a color image; or/and a four dimensional signal, such as a dynamic 3D mesh or a color video signal; or/and a five dimensional signal such as a stereo color video signal. The object which contains a combination of the signals mentioned above can be referred as a multimedia object.

3. Apparatus as claimed in claim 1, wherein said the communication media is a wireless link, a twisted pair cable, a coaxial cable, a fiber optic link, or a waveguide.

4. Apparatus as claimed in claim 1, wherein said the agents are be human or/and not human. The not human agent is represented by a hardware device or/and a firmware program or/and a software program.

5. Apparatus as claimed in claim 1, wherein said the efficient data communication is provided by monitoring of time-varying characteristics of all components, such as a charge of batteries and a status of all hardware, firmware and software components. The efficient data communication is also provided using the information about time-invariant characteristics of the systems, such as devices screen sizes, employed operational systems (OS), etc.

6. (canceled)

7. (canceled)

8. (canceled)

9. (canceled)

10. (canceled)

11. (canceled)

12. A W_{N} cell (N=2ⁿ, n ∈ Z) can be used both for the data analysis and synthesis.

13. A technique of modeling of the wireless channel profile using the W_{N} cell (N=2ⁿ, n ∈ Z). The obtained channel model predicts attenuations of each of subbands. Use of this information allows organizing datastream coding, mapping and multiplexing more efficiently.
